(19) United States
(12) Patent Application Publication
(10) Pub. No.: US 2010/0148619 A1
(43) Pub. Date: Jun. 17, 2010

(54) STATOR AND WIRE WINDING METHOD THEREFOR

(75) Inventor: Xu ZHANG, Zhongshan (CN)

Correspondence Address: MATTHIAS SCHOLL, 14781 MEMORIAL DRIVE, SUITE 1319, HOUSTON, TX, 77079, US

(73) Assignee: Zhongshan Broad-Ocean Motor Co., Ltd., Zhongshan (CN)

(21) Appl. No.: 12/502,407

(22) Filed: Jul. 14, 2009

(30) Foreign Application Priority Data
Dec. 12, 2008 (CN) 200810220114.1

(51) Int. Cl. H02K 3/28

(52) U.S. Cl. 310/195

(57) ABSTRACT

A stator, comprising a stator iron core, a plurality of stator windings comprising multiple in-phase windings and anti-phase windings, a plurality of end insulators, a plurality of teeth, and a plurality of slots. The winding wires of the in-phase windings are firstly wrapped around two adjacent teeth and then cross four teeth thereof. A wire winding method for a stator, comprising: wrapping the winding wires of the in-phase windings around two adjacent teeth; crossing four teeth; and wrapping the winding wires of the in-phase windings around next two adjacent teeth. The winding directions of the two adjacent teeth of the in-phase windings are opposite. The winding directions of adjacent teeth of the anti-phase windings are the same.

### CROSS-REFERENCE TO RELATED APPLICATIONS

Pursuant to 35 U.S.C. §119 and the Paris Convention Treaty, this application claims priority benefits to Chinese Patent Application No. 200810220114.1, filed on Dec. 12, 2008, the contents of which are incorporated herein by reference.

### BACKGROUND OF THE INVENTION

1. Field of the Invention

The invention relates to a stator, and particularly to a motor stator and a wire winding method therefor.

2. Description of the Related Art

Conventional stators comprise a stator iron core, a plurality of end insulators, and a stator winding. A plurality of teeth protrudes from a side wall of the stator iron core. A plurality of slots is formed between adjacent teeth. The stator winding is received in the slot and wrapped around the teeth.

In a conventional wire winding method for the stator winding, shown in FIG. 3, winding directions for all the teeth are the same: clockwise or anticlockwise, and winding wires are wrapped around the first tooth, cross two sequential teeth, and are then wrapped around the fourth tooth. However, there are some problems with this method. For example, the cogging torque of the stator is high, and thus the motor vibrates vigorously during operation and its working life is decreased.

### SUMMARY OF THE INVENTION

In view of the above-described problems, it is one objective of the invention to provide a stator that features a small cogging torque and is thus capable of operating smoothly and has long working life.

It is another objective of the invention to provide a wire winding method that is simple and facilitates a stator with a small cogging torque, and thus makes the stator capable of operating smoothly and having long working life.

To achieve the above objectives, in accordance with one embodiment of the invention, provided is a stator, comprising a stator iron core, a plurality of stator windings comprising multiple in-phase windings and anti-phase windings, a plurality of end insulators, a plurality of teeth, and a plurality of slots, wherein the teeth protrude from the side wall of the stator iron core, the slots are formed between adjacent teeth, and the stator winding is received in the slot and wrapped around the teeth, and the winding wires of the in-phase windings are firstly wrapped around two adjacent teeth and then cross four teeth of the stator.

In certain embodiments of the present invention, winding directions of the two adjacent teeth of the in-phase windings are opposite.

In certain embodiments of the present invention, winding directions of adjacent teeth of the anti-phase windings are the same.

In certain embodiments of the present invention, the number of the teeth is 36.

In certain embodiments of the present invention, the stator winding comprises a U-phase winding, a V-phase winding, and a W-phase winding.

In certain embodiments of the present invention, winding wires of the U-phase winding wrap around the 1^{st}, the 2^{nd}, the 7^{th}, the 8^{th}, the 13^{th}, the 14^{th}, the 19^{th}, the 20^{th}, the 25^{th}, the 26^{th}, the 31^{th}, and the 32^{th} tooth.

In certain embodiments of the present invention, winding wires of the V-phase winding wraps around the 3^{rd}, the 4^{th}, the 9^{th}, the 10^{th}, the 15^{th}, the 16^{th}, the 21^{th}, the 22^{th}, the 27^{th}, the 28^{th}, the 33^{th}, and the 34^{th} tooth.

In certain embodiments of the present invention, winding wires of the W-phase winding wraps around the 5^{th}, the 6^{th}, the 11^{th}, the 12^{th}, the 17^{th}, the 18^{th}, the 23^{th}, the 24^{th}, the 29^{th}, the 30^{th}, the 35^{th}, and the 36^{th} tooth.

In certain embodiments of the present invention, the stator winding is enamel insulated aluminum wire.

In certain embodiments of the present invention, the stator winding is enamel insulated copper wire.

In accordance with another embodiment of the invention, provided is a wire winding method, comprising: providing a plurality of slots, teeth and stator windings comprising multiple in-phase windings and anti-phase windings, said slots being formed between adjacent teeth, and said stator winding being received in said slot and wrapped around said teeth, wrapping said winding wires of said in-phase windings around two adjacent teeth, crossing four teeth, and wrapping said winding wires of said in-phase windings around the next two adjacent teeth; wherein the winding directions of said two adjacent teeth of said in-phase windings are opposite, and the winding directions of adjacent teeth of said anti-phase windings are the same.

Advantages of the invention include:
1. the wire winding method of the invention is simple and practical;
2. the stator winding of the invention enables the cogging torque to be reduced, and thus the motor operates more smoothly;
3. vibration and noise of the motor are reduced; and
4. the failure rate of the motor is decreased, and working life thereof is increased.

### BRIEF DESCRIPTION OF THE DRAWINGS

Detailed description will be given below with reference to accompanying drawings, in which:

FIG. 1 is a schematic view of a stator of an exemplary embodiment of the invention;

FIG. 2 illustrates a wire winding method of an exemplary embodiment of the invention; and

FIG. 3 illustrates a conventional wire winding method.

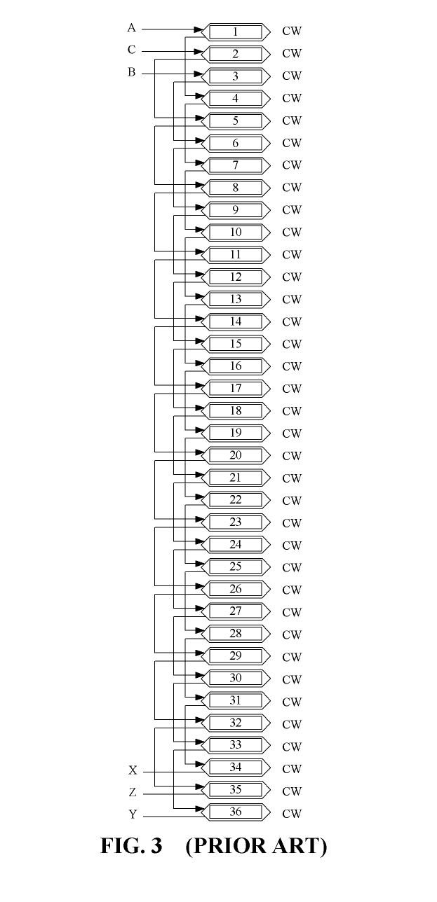

### DETAILED DESCRIPTION OF THE EMBODIMENTS

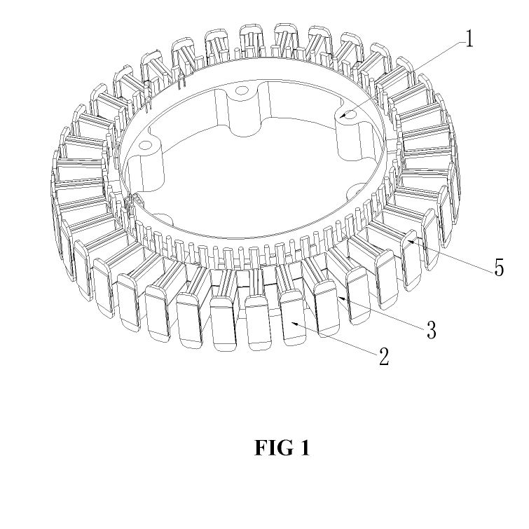

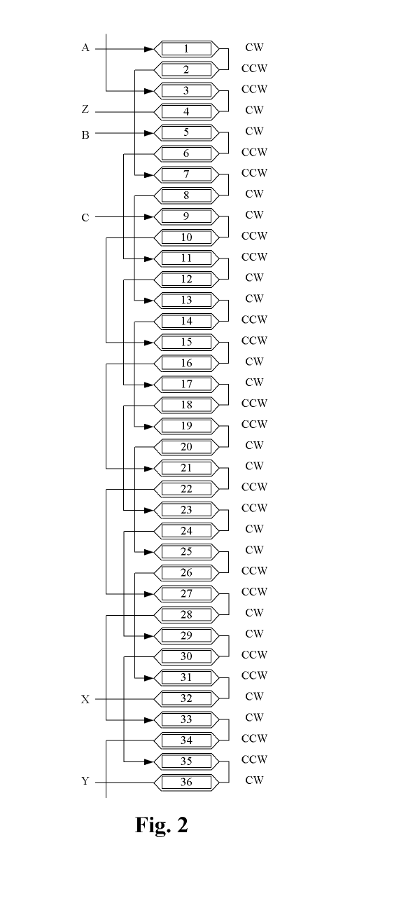

As shown in FIGS. 1 and 2, a stator of the invention comprises a stator iron core 1, a plurality of stator windings 4 comprising multiple in-phase windings and anti-phase windings, a plurality of end insulators 5, a plurality of teeth 2, and a plurality of slots 3. The teeth 2 protrude from the side wall of the stator iron core 1, the slots 3 are formed between adjacent teeth 2, and the stator winding 4 is received in the slot 3 and wrapped around the teeth 2.

As shown in FIG. 2, winding wires of the in-phase windings 4 are firstly wrapped around two adjacent teeth 2, then cross four teeth 2, and so on until they wrap around the entire stator in a complete circle. Winding directions of the two adjacent teeth 2 of the in-phase windings 4 are opposite, and winding directions of adjacent teeth 2 of the anti-phase windings 4 are the same. The stator winding 4 comprises a U-phase winding, a V-phase winding, and a W-phase winding. In this embodiment, the number of the teeth 2 is 36. As shown in FIG. 2, the teeth 2 are sequentially numbered from 1 to 36.

### EXAMPLE 1

### Three-phase Stator Winding

For a motor with a three-phase stator winding, a wire winding method comprises the following steps.

For U-phase winding with two ends A and X:

1) wrapping winding wires around the 1^{st} tooth in the clockwise direction;

2) wrapping winding wires around the 2^{nd} tooth in the anticlockwise direction;

3) crossing 4 sequential teeth and wrapping winding wires around the 7^{th} tooth in the anticlockwise direction;

4) wrapping winding wires around the 8^{th} tooth in the clockwise direction;

5) wrapping winding wires around the 13^{th} tooth and the 14^{th} tooth;

6) crossing 4 sequential teeth and wrapping winding wires around the 19^{th} tooth and the 20^{th} tooth;

7) wrapping winding wires around the 25^{th} tooth and the 26^{th} tooth; and

8) crossing 4 sequential teeth and wrapping winding wires around the 31^{th} tooth and the 32^{th} tooth.

For V-phase winding with two ends B and Y:

1) wrapping winding wires around the 3^{rd} tooth in the clockwise direction;

2) wrapping winding wires around the 4^{th} tooth in the anticlockwise direction;

3) crossing 4 sequential teeth and wrapping winding wires around the 9^{th} tooth in the anticlockwise direction;

4) wrapping winding wires around the 10^{th} tooth in the clockwise direction;

5) wrapping winding wires around the 15^{th} tooth and the 16^{th} tooth;

6) crossing 4 sequential teeth and wrapping winding wires around the 21^{th} tooth and the 22^{th} tooth;

7) wrapping winding wires around the 27th tooth and the 28th tooth;

8) crossing 4 sequential teeth and wrapping winding wires around the 33th tooth and the 34th tooth.

For W-phase winding with two ends C and Z:

1) wrapping winding wires around the 5^{th} tooth in the clockwise direction;

2) wrapping winding wires around the 6^{th} tooth in the anticlockwise direction;

3) crossing 4 sequential teeth and wrapping winding wires around the 11^{th} tooth in the anticlockwise direction;

4) wrapping winding wires around the 12^{th} tooth in the clockwise direction;

5) wrapping winding wires around the 17^{th} tooth and the 18^{th} tooth;

6) crossing 4 sequential teeth and wrapping winding wires around the 23^{th} tooth and the 24^{th} tooth;

7) wrapping winding wires around the 29^{th} tooth and the 30^{th} tooth; and

8) crossing 4 sequential teeth and wrapping winding wires around the 35^{th} tooth and the 36^{th} tooth.

### EXAMPLE 2

### Three-phase Stator Winding

For a motor with a three-phase stator winding, a wire winding method comprising the following steps:

For U-phase winding:

1) wrapping winding wires around the 1^{st} tooth in the anticlockwise direction;

2) wrapping winding wires around the 2^{nd} tooth in the clockwise direction;

3) crossing 4 sequential teeth and wrapping winding wires around the 7^{th} tooth in the clockwise direction;

4) wrapping winding wires around the 8^{th} tooth in the anticlockwise direction;

5) wrapping winding wires around the 13^{th} tooth and the 14^{th} tooth;

6) crossing 4 sequential teeth and wrapping winding wires around the 19^{th} tooth and the 20^{th} tooth;

7) wrapping winding wires around the 25^{th} tooth and the 26^{th} tooth;

8) crossing 4 sequential teeth and wrapping winding wires around the 31^{th} tooth and the 32^{th} tooth.

For V-phase winding:

1) wrapping winding wires around the 3^{th} tooth in the anticlockwise direction;

2) wrapping winding wires around the 4^{th} tooth in the clockwise direction;

3) crossing 4 sequential teeth and wrapping winding wires around the 9^{th} tooth in the clockwise direction;

4) wrapping winding wires around the 10^{th} tooth in the anticlockwise direction;

5) wrapping winding wires around the 15^{th} tooth and the 16^{th} tooth;

6) crossing 4 sequential teeth and wrapping winding wires around the 21^{th} tooth and the 22^{th} tooth;

7) wrapping winding wires around the 27^{th} tooth and the 28^{th} tooth; and

8) crossing 4 sequential teeth and wrapping winding wires around the 33^{th} tooth and the 34^{th} tooth.

A W-phase winding:

1) wrapping winding wires around the 5^{th} tooth in the anticlockwise direction;

2) wrapping winding wires around the 6^{th} tooth in the clockwise direction;

3) crossing 4 sequential teeth and wrapping winding wires around the 11^{th} tooth in the clockwise direction;

4) wrapping winding wires around the 12^{th} tooth in the anticlockwise direction;

5) wrapping winding wires around the 17^{th} tooth and the 18^{th} tooth;

6) crossing 4 sequential teeth and wrapping winding wires around the 23^{th} tooth and the 24^{th} tooth;

7) wrapping winding wires around the 29^{th} tooth and the 30^{th} tooth; and

8) crossing 4 sequential teeth and wrapping winding wires around the 35^{th} tooth and the 36^{th} tooth.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What claimed is:

1. A stator, comprising
a stator iron core;
a plurality of stator windings comprising multiple in-phase windings and anti-phase windings;
a plurality of end insulators;
a plurality of teeth; and
a plurality of slots;
wherein
said teeth protrude from the side wall of said stator iron core;
said slots are formed between adjacent teeth; and
said stator winding is received in said slot and wrapped around said teeth; and
said winding wires of said in-phase windings are firstly wrapped around two adjacent teeth and then cross four teeth.

2. The stator of claim 1, wherein, winding directions of said two adjacent teeth of said in-phase windings are opposite.

3. The stator of claim 1, wherein winding directions of adjacent teeth of said anti-phase windings are the same.

4. The stator of claim 1, wherein the number of said teeth is 36.

5. The stator of claim 1, wherein said stator winding comprises a U-phase winding, a V-phase winding, and a W-phase winding.

6. The stator of claim 5, wherein winding wires of said U-phase winding wrap around the 1^{st}, the 2^{nd}, the 7^{th}, the 8^{th}, the 13^{th}, the 14^{th}, the 19^{th}, the 20^{th}, the 25^{th}, the 26^{th}, the 31^{th}, and the 32^{th} tooth.

7. The stator of claim 5, wherein winding wires of said V-phase winding wrap around the 3^{rd}, the 4^{th}, the 9^{th}, the 10^{th}, the 15^{th}, the 16^{th}, the 21th, the 22th, the 27^{th}, the 28^{th}, the 33^{th}, and the 34^{th} tooth.

8. The stator of claim 5, wherein winding wires of said W-phase winding wrap around the 5^{th}, the 6^{th}, the 11^{th}, the 12^{th}, the 17^{th}, the 18^{th}, the 23th, the 24^{th}, the 29^{th}, the 30^{th}, the 35^{th}, and the 36^{th} tooth.

9. The stator of claim 1, wherein said stator winding is enamel insulated aluminum wire.

10. The stator of claim 1, wherein said stator winding is enamel insulated copper wire.

11. A wire winding method, comprising
providing a plurality of slots, teeth, and stator windings comprising multiple in-phase windings and anti-phase windings, said slots being formed between adjacent teeth, and said stator winding being received in said slot and wrapped around said teeth;
wrapping said winding wires of said in-phase windings around two adjacent teeth; and
crossing four teeth and wrapping said winding wires of said in-phase windings around next two adjacent teeth;
wherein
winding directions of said two adjacent teeth of said in-phase windings are opposite; and
winding directions of adjacent teeth of said anti-phase windings are the same.
